(19) United States
(12) Patent Application Publication
(10) Pub. No.: US 2013/0041900 A1
(43) Pub. Date: Feb. 14, 2013

(54) Script Reuse and Duplicate Detection

(71) Applicants: Daniel P. McCoy, Jacksonville, FL (US); Constance A. Clayton, South Windsor, CT (US); Bharath Aravamuthan, Jacksonville, FL (US)

(72) Inventors: Daniel P. McCoy, Jacksonville, FL (US); Constance A. Clayton, South Windsor, CT (US); Bharath Aravamuthan, Jacksonville, FL (US)

(73) Assignee: BANK OF AMERICA CORPORATION, Charlotte, NC (US)

(21) Appl. No.: 13/207,094

(22) Filed: Aug. 10, 2011

(51) Int. Cl. G06F 17/30

(52) U.S. Cl. 707/737; 707/E17.009; 707/E17.046

(57) ABSTRACT

A script repository (embodied, for instance, as a SQL server database) of re-usable scripts may be provided that houses scripts previously developed and/or executed as part of a prior testing effort. The script repository may be searched to view and/or download one or more test scripts based on one or more search criteria, and/or may be checked for duplicate scripts. A development team thus may be able to easily find appropriate scripts for re-use based on particular testing requirements. At the end of testing, the information on the portion (e.g., percentage) of scripts that were re-used by the developers may be collected and reported on a periodic basis.

### BACKGROUND

During user acceptance testing execution of enterprise information management integrated projects, an integrated testing management team typically obtains computer-executable test scripts from development teams. Such test scripts may be in the form of, e.g., structured query language (SQL) scripts. These test scripts may be reviewed against business requirements and low-level design documentation to ensure the project scope has been covered. Upon confirmation, these test scripts may be modified and passed to a quality control department for execution of user acceptance testing, including regression testing.

Such test scripts are typically custom-created from scratch on an as-needed basis. Even if a similar test script has been used before, there may be no easy way to methodically find the appropriate test script for incorporation into the current test.

### SUMMARY

As will be described by way of example herein, test cases that have been previously created and executed as part of an earlier project effort may be cataloged, searched, and re-used. This may be desirable where, for example, future testing is expected to involve at least some replication of previous production structures, and where new code changes include testing of existing job flows/streams. Accordingly, this may provide an opportunity to leverage test scripts created from prior testing efforts, thereby potentially improving efficiency of future testing efforts.

To accomplish this and potentially reduce the time involved in creating test scripts for every project, a script repository (embodied, for instance, as a SQL server database) of re-usable scripts may be created. The script repository may house scripts that were previously developed and/or executed as part of a prior testing effort.

In addition, one or more modules (which may be implemented, e.g., as one or more software applications such as a web-based tool) may be provided that allow for searches of the script repository to view and/or download one or more test scripts based on one or more search criteria, for uploading new scripts, for detecting duplicate scripts, and/or for performing other maintenance tasks. Using such module(s), a development team may be able to easily find appropriate scripts for re-use based on particular testing requirements. At the end of testing, the information on the portion (e.g., percentage) of scripts that were re-used by the developers may be collected and reported on a periodic basis.

To keep the script repository up-to-date, upload and house-keeping activities may be performed, such as by collecting and/or consolidating previously executed scripts (such as those scripts that were previously used as part of a release), validating script repository tags (fields), identifying potentially duplicate scripts in the script repository, and uploading of new scripts to the script repository. Such upload and house-keeping activities may be performed on an as-needed basis, or periodically, for example. For instance, the activities may be performed at the end of each test cycle.

Duplicate detection may also be performed periodically or whenever a new script is uploaded to the script repository. Duplicate detection may involve comparing one or more characteristics of the script to be uploaded with characteristics of scripts already stored in the script repository. If there is a suspected match, then either the new script upload may be automatically aborted, or the new script upload may be tagged for manual (human) review to make a final determination as to whether the new script upload duplicates an existing script already stored in the script repository. Characteristics for comparison may include, e.g., a description of the script or the functionality of the script, a script category, and/or one or more hash values (e.g., a checksum) based on one or more fields characterizing the script.

These and other aspects of the disclosure will be apparent upon consideration of the following detailed description.

### BRIEF DESCRIPTION OF THE DRAWINGS

A more complete understanding of the present disclosure and the potential advantages of various aspects described herein may be acquired by referring to the following description in consideration of the accompanying drawings, in which like reference numbers indicate like features, and wherein:

FIG. 1 is a block diagram of an example system that may be used in accordance with one or more aspects as described herein;

FIG. 2 is a block diagram of an example computer in accordance with one or more aspects as described herein;

FIG. 3 is a flow chart of example steps that may be performed to interact with a script repository in accordance with one or more aspects as described herein; and

FIG. 4 is another flow chart of example steps that may be performed to interact with a script repository in accordance with one or more aspects as described herein.

### DETAILED DESCRIPTION

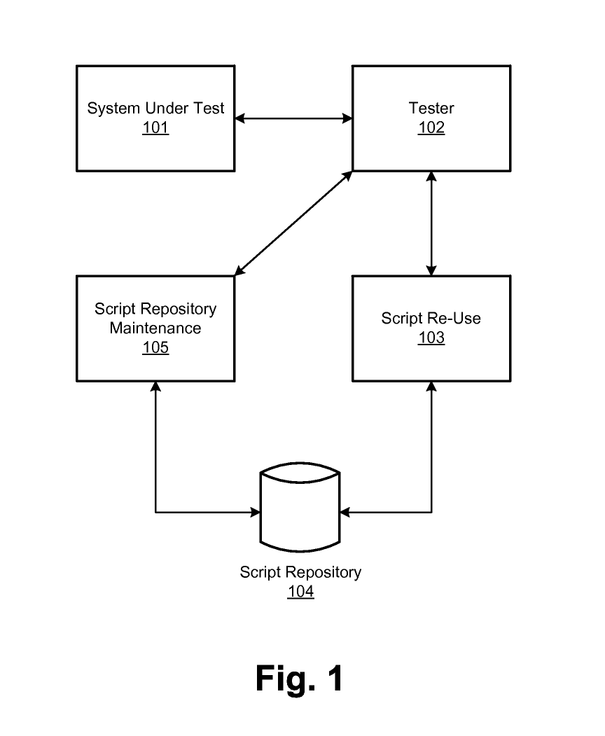

FIG. 1 is a block diagram of an example system that may be used in accordance with one or more aspects as described herein. In the example shown, the system includes a system under test 101, a tester 102, a script re-use module 103, a script repository 104, and a script repository maintenance module 105.

The system under test 101 represents a system that is to be tested by tester 102. The system under test 101 may be or otherwise include any type of tangible apparatus, such as one or more computers, and/or one or more processes or functions, such as a business process. The tester 102 may test the system under test 101 by sending and/or receiving information to and/or from the system under test 101, and/or by causing certain functions, processes, and/or other elements of the system under test 101 to operate under a test condition. In doing so, the tester 102 may execute one or more scripts in the form of computer-readable instructions that will cause the system under test 101 to take particular actions and/or otherwise perform in a particular way. The results of the testing may be provided back to the tester 102. For example, the tester 102 may wish to test the impact of a particular software or database change to the system under test 101. To test this change, the tester 102 may cause one or more scripts to be executed by the system under test 101 and/or by a computer external to the system under test 101.

The tester 102 may be or otherwise include an apparatus, system, and/or organization entity such as a development team. For example, the tester 102 may be or otherwise include one or more computers and/or personnel that are capable of preparing scripts for execution by and/or otherwise using the system under test 101. In preparing the scripts, the tester 102 may create new scripts from scratch, re-use scripts that were previously used by the tester 102 or by another entity, and/or create scripts based on such previously-used scripts. Scripts that have been previously used may be stored in the script repository 104 and may be searchable and accessible via the script re-use module 103.

The script repository maintenance module 105 may be used to perform various maintenance functions in conjunction with the script repository 104, including, for instance, uploading scripts to the script repository 104, detecting suspected duplicate scripts already existing in the script repository 104 and/or in scripts to be uploaded, and/or performing other maintenance functions on the script repository 104. The script re-use module 103 may be used by a user such as tester 102 to query the script repository for scripts based on one or more search characteristics. The script re-use module 103 may also allow a user to obtain reports based on the queries and/or on the status of the script repository 104.

The script re-use module 103 and/or the script repository maintenance module 105 may be implemented together or separately as, for instance, one or more software applications running on one or more computers. For example, where the tester 102 communicates with the script re-use module 103 and/or the script repository maintenance module 105 via a network such as the Internet or an intranet, the modules 103 and/or 105 may include a web browser accessible user interface. In such a case, the web browser may run on a computer of the tester 102, and the modules 103 and/or 105 may operate at least partially on a web server. However, any type of software and user interface may be used to implement the modules 103 and/or 105. Moreover, while various functions are attributed by way of example to the modules 103 and/or 105 as described herein, some or all of these functions may be further broken into multiple independent software tools, or combined into a single software tool, as desired.

As previously mentioned, various elements described herein may be partially or fully implemented by one or more computers. For instance, any of blocks 101, 102, 103, 104, and/or 105 may be or otherwise include a computer. A computer may include any electronic, electro-optical, and/or mechanical device, or system of multiple physically separate such devices, that is able to process and manipulate information, such as in the form of data. Non-limiting examples of a computer include one or more personal computers (e.g., desktop, tablet, or laptop), servers, smart phones, personal digital assistants (PDAs), digital video recorders, mobile computing devices, and/or a system of these in any combination or subcombination. In addition, a given computer may be physically located completely in one location or may be distributed amongst a plurality of locations (i.e., may implement distributive computing). A computer may be or include a general-purpose computer and/or a dedicated computer configured to perform only certain limited functions.

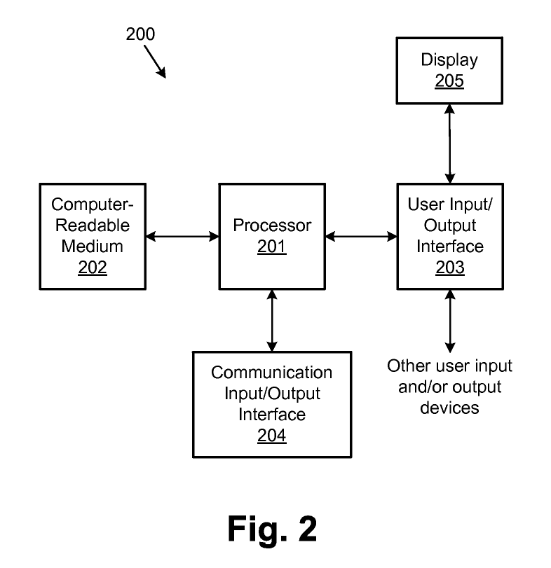

An example functional-block representation of a computer 200 is shown in FIG. 2.

Computer 200 may include hardware that may execute software to perform specific functions. The software, if any, may be stored on a tangible non-transitory computer-readable medium 202 in the form of computer-readable instructions. Computer 200 may read those computer-readable instructions, and in response perform various steps as defined by those computer-readable instructions. Thus, any functions and operations at least partially attributed to a computer and/or a user interface may be implemented, for example, by reading and executing such computer-readable instructions for performing those functions, and/or by any hardware subsystem (e.g., a processor 201) from which computer 200 is composed. Additionally or alternatively, any of the above-mentioned functions and operations may be implemented by the hardware of computer 200, with or without the execution of software.

Computer-readable medium 202 may include, e.g., a single physical non-transitory medium or single type of such medium, or a combination of one or more such media and/or types of such media. Examples of computer-readable medium 202 include, but are not limited to, one or more memories, hard drives, optical discs (such as CDs or DVDs), magnetic discs, and magnetic tape drives. Computer-readable medium 202 may be physically part of, or otherwise accessible by, computer 200, and may store computer-readable data representing computer-executable instructions (e.g., software) and/or non-executable data.

Computer 200 may also include a user input/output interface 203 for receiving input from a user via a user input device (e.g., a keyboard, a mouse, touch-sensitive display, and/or a remote control) and providing output to the user via a user output device (e.g., a display device 205, an audio speaker, and/or a printer). Display device 205 may be any device capable of presenting information for visual consumption by a human, such as a television, a computer monitor or display, a touch-sensitive display, or a projector. Computer 200 may further include a communication input/output interface 204 for communicating with devices external to computer 200, such as with other computers and/or other nodes in a network.

As previously discussed, script repository 104 may be maintained by uploading new scripts to script repository 104, detecting duplicate scripts in script repository 104 and/or in scripts to be uploaded, and/or other maintenance activities on a periodic and/or as-needed basis.

In addition to storing the actual scripts themselves, script repository 104 may store one or fields (e.g., database fields) associated with each script. The fields may be derived from the scripts themselves and/or from manually-entered information about the scripts. Thus, to populate such fields, as scripts are collected for upload to the repository, each script may be analyzed and tagged with one or more characteristics. Each characteristic of the script may be stored in a separate field in the repository database entry for the script, each field being searchable. The characteristics may be determined manually and/or automatically, such as by using a set of Microsoft EXCEL macros. Examples of characteristic fields that may be generated for each script to be stored in the script repository may include (but are not necessarily limited to):

TABLE 1

| FIELD | DESCRIPTION |
|---|---|
| LOB | The domain to which the table/view(s) referenced |
| | in the SQL test script belong to. |
| SOR | The System of Record (data source) which was |
| | tested as part of the project testing. |
| TEST TYPE | The type of the test script (e.g., development |
| | or regression). |
| FREQUENCY | Load frequency of the view(s) referenced in the |
| | SQL test script. |
| RELEASENAME | The Integrated Release to which the project |
| | deployment belonged. |
| PROJECT/ | Individual project name for which the test scripts |
| TRANSITION | were executed. |
| DATABASENAME | Database name(s) used in the SQL script (Ref to |
| | Test Env may be seen). |
| TABLENAME | Table/View name on which the test script is |
| | created (Ref to Test Env may be seen). |
| ALIASNAME | Aliases used in the SQL Script. This is used |
| | to expand the Script by replacing them with |
| | the original Database and table names. |
| NEWQUERY | Formatted version of the script itself (e.g., |
| | SQL script), in which all the non-readable |
| | characters and spaces may be removed, the case |
| | may be changed to upper-case, and/or the alias |
| | names may be expanded. |
| HASH | Hashing of one or more of the fields for the |
| | script, which may be used for duplicate detec- |
| | tion. For instance, the hash value may be the |
| | sum of the ASCII values (or other coded |
| | values) of the text characters obtained from |
| | fields such as NEWQUERY, FREQUENCY, |
| | DATABASENAME, and/or TABLENAME. |
| | A non-limiting example of a hash value is a |
| | checksum. |

Other characteristic fields that may be associated with scripts in script repository 104 may include one or more tags identifying a status of the associated script. For instance, a tag in a characteristic field for a script may identify whether the script is a suspected duplicate, whether the script is newly uploaded, and/or whether the script has ever been included in a search result.

Once some or all of the characteristics as desired are determined, script repository maintenance module 105 may be used to upload the scripts and their associated characteristics into script repository 104. And, upon upload or at any subsequent time, certain characteristics may be added for a script. For instance, each of the uploaded scripts may be checked for duplicates in script repository 104. Such duplicate detection may be performed before, during, or after uploading of the scripts, to verify that there are no duplicate/redundant scripts that may later be returned from script repository 104 as part of a script repository search. Once duplicates are detected, each duplicate that is considered functionally and/or technically equivalent to existing script may be removed from, and/or tagged in, script repository 104. Moreover, one or more fields of the script to be uploaded and the existing script in the script repository may be merged to help prevent information in those fields from becoming lost. Tagging and/or removal may be performed on the newly uploaded script (or script to be newly uploaded), and/or this may be performed on the earlier script already stored in script repository 104. Where the script to be uploaded is determined to be a duplicate prior to uploading to script repository 104, that script may be prevented from being uploaded in the first place.

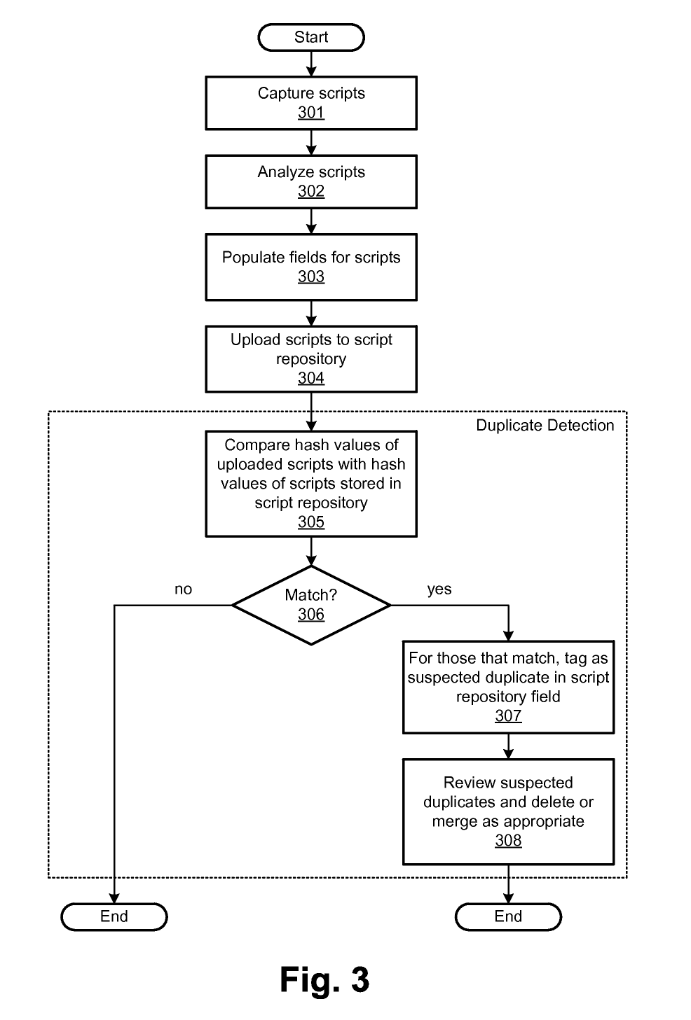

FIG. 3 is a flow chart showing example steps that may be performed, which may utilize script repository maintenance module 105 and/or script repository 104. At step 301, scripts previously used in testing may be captured and prepared for uploading by script repository maintenance module 105 to script repository 104. This may involve, for instance, manually determining which scripts should be uploaded. Or, this may involve obtaining the scripts from another repository such as another database. At step 302, the scripts may be analyzed to determine one or more characteristics associated with each of the scripts. As previously mentioned, this may involve automated analysis by a computer and/or manual analysis by a human.

In one example, the scripts may be entered into a software application such as the

Microsoft EXCEL spreadsheet software application, and at least some of the characteristics may be automatically extracted based on the content of the scripts themselves, such as using Microsoft EXCEL macros. Others of the characteristics may be manually entered (e.g., into the Micorsoft EXCEL spreadsheet) via a user interface of the software application.

Step 302 may further include determining a hash value for each of the scripts to be uploaded. As discussed previously, for a given one of the scripts, the hash value may be based on a single field or a combination of fields of the script. For example, the hash value may be the sum of the ASCII values of the text obtained from one or more of the fields. In one example, the hash may be a checksum of the text in the fields NEWQUERY, FREQUENCY, DATABASENAME, and TABLENAME. For instance, where the fields are as shown in Table 2:

TABLE 2

| FIELD | TEXT VALUE |
|---|---|
| FREQUENCY | DAILY |
| DATABASENAME | Name1 |
| TABLENAME | Table1 |
| NEWQUERY | SELECTNAMEFROMNAME1.TABLE1 |

In this case, the ASCII values of each character in these fields would be as shown in Table 3:

TABLE 3

| FIELD | SUMMED ASCII VALUES (decimal) |
|---|---|
| FREQUENCY | 371 |
| DATABASENAME | 338 |
| TABLENAME | 409 |
| NEWQUERY | 1838 |

TThe four values in this example may be combined in any way desired to determine the hash value. For example, they may be added, subtracted, divided, multiplied, and/or using any other mathematical linear or non-linear function. For example, HASH might be calculated by combining the ASCII summed values as follows: HASH=ASCII(NEWQUERY)+ASCII(FREQUENCY)+ASCII(TABLENAME)−ASCII(DATABASENAME). In the above example, this would result in HASH=1838+371+409−338=2280. Of course, other combinations and subcombinations of fields and values are possible. For instance, the hash value may simply be the sum of the ASCII values of the NEWQUERY field. Also, while decimal ASCII coding is used, other counting systems (e.g., hexadecimal) and coding systems may be utilized as desired.

Once the characteristics including the hash value are obtained, then at step 303, the fields for the scripts (including the hash value) may be populated with the appropriate characteristics in preparation for upload to script repository 104. At step 304, script repository maintenance module 105 may be used to upload the scripts and their related characteristic fields (including their hash values) to script repository 104.

Next, script repository maintenance module 105 may perform a duplicate detection function (steps 305-308). Alternatively, at least some of the duplicate detection function may be performed by a human, which may be assisted by repository maintenance module 105. Duplicate detection may be performed on a script-by-script basis as each script is uploaded, or on a batch-by-batch basis after as each batch of scripts is uploaded. At step 305, script repository maintenance module 105 may perform queries of script repository 104 to compare the hash values of the script just uploaded with the stored hash values of scripts already in script repository 104. For instance, using the above example of Table 2, if the hash value of the script recently uploaded is 2280 and another existing script in script repository 104 is also 2280, then this is an indication that the two scripts are likely duplicates of each other. In further embodiments, each script may have multiple hash values, such as one for each of a plurality of the fields. In these embodiments, each of the scripts for a given pair of scripts being checked for duplication may be compared. If all of the hash values of the pair of scripts are identical, then this would also indicate a likely duplication. If, however, all hash values are identical except for one (or two, etc.), this may also indicate a likely duplication, but perhaps with a lesser degree of certainty. Thus, an especially where the hash values are chosen to be meaningful, the number of hash values matching between a given pair of scripts may be an indication as to how likely the two scripts duplicate each other.

At step 306, if it is determined that there is no match between the hash value(s) of a script just uploaded with the hash value(s) of another script in script repository 104, then no further action is needed for that script.

On the other hand, if at step 306 is it determined that the hash value (or multiple hash values) of a just-uploaded script matches the hash value (or multiple hash values) of another script in script repository 104, then the process moves to step 308, at which point any of a number of things may occur. For instance, script repository maintenance module 105 may set a tag field for the recently uploaded script having the matching hash value, indicating that the script is a suspected duplicate. Where multiple hash values per script are used, the tag may also contain a value indicating the level of suspicion of the duplication (e.g., 1=1 possible, but less likely; 2=likely; 3=very likely), depending upon how many of the hash value pairs match between the pair of scripts.

At any later time, script repository 104 may be queried for those scripts having the set tag indicating a suspected duplicate, and those queries may be manually reviewed by a human to verify whether the script is actually a duplicate. If not, then the tag is un-set and the script remains in script repository 104. If so, then the script may be removed from script repository 104 and/or merged with the existing script that is duplicates. In further embodiments, the script determined to be a duplicate may be automatically removed by script repository maintenance module 105, without waiting for manual intervention. In that case, it may be desirable to allow a human to later manually review the removed scripts and determine whether they should be added back in to script repository 104 or merged with an existing script in script repository 104.

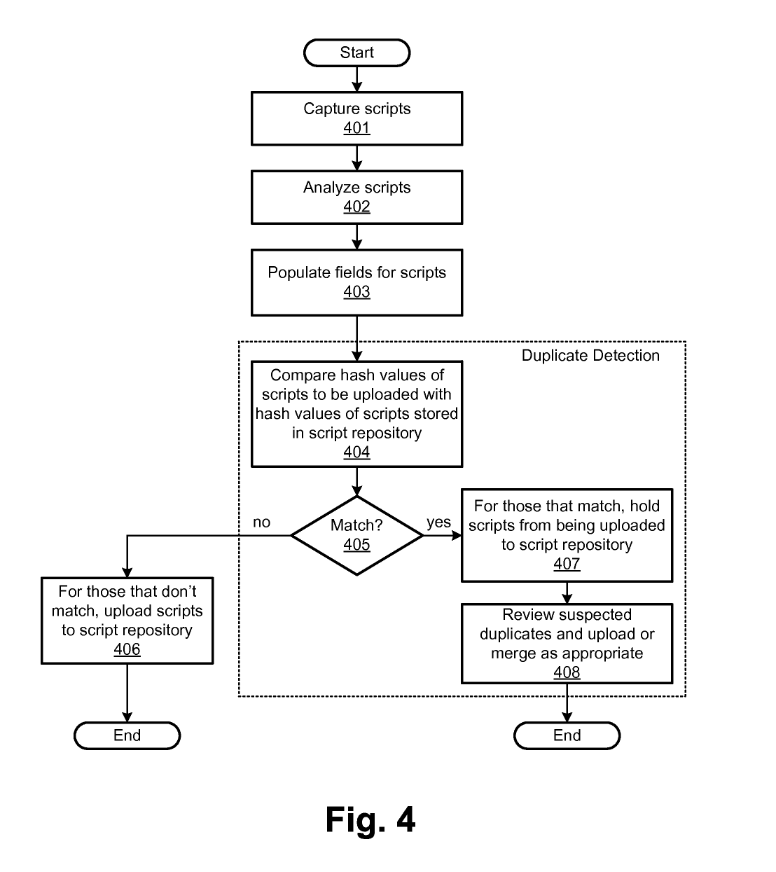

FIG. 4 shows another example, in which the duplicate detection function may be performed prior to script upload. In this example, steps 401-403 may be identical to steps 301-303, respectively. At step 404, script repository maintenance module 105 may perform queries of script repository 305 to compare the hash values of the script about to be uploaded with the stored hash values of scripts already in script repository 104. Again, using the above example of Table 2, if the hash value of the script about to be uploaded is 2280 and another existing script in script repository 104 is also 2280, then this is an indication that the two scripts are likely duplicates of each other. Again, it is also possible that each script may have multiple hash values, such as one for each of a plurality of the fields. In these embodiments, each of the scripts for a given pair of scripts being checked for duplication may be compared. If all of the hash values of the pair of scripts are identical, then this would also indicate a likely duplication. If, however, all hash values are identical except for one (or two, etc.), this may also indicate a likely duplication, but perhaps with a lesser degree of certainty. Thus, an especially where the hash values are chosen to be meaningful, the number of hash values matching between a given pair of scripts may be an indication as to how likely the two scripts duplicate each other.

At step 405, if it is determined that there is no match between the hash value(s) of a script about to be uploaded with the hash value(s) of another script in script repository 104, then at step 406, the script may be uploaded to script repository 104 as planned.

On the other hand, if at step 405 is it determined that the hash value (or multiple hash values) of the script about to be loaded matches the hash value (or multiple hash values) of another script in script repository 104, then the script is a suspected duplicate, and the process moves to step 407, at which point the intended uploading of the script may be aborted, or else the script may be merged with the existing script in script repository 104. Script repository maintenance module 105 may further provide a report for manual review by a human to verify whether the aborted script is actually a duplicate. The report may further include an indication as discussed above as to how likely the duplication is.

At step 408, if it is determined by the human that the script is not a duplicate, then the script may be uploaded to script repository 104. If, the script is verified as being a duplicate, then the script may continue to not be uploaded (the abort may be verified) or the script may be merged with the other script in script repository 104.

In either of the examples of FIGS. 3 and 4, any of the steps may be performed automatically by software and/or manually by a human (possibly with the assistance of software). For example, at steps 305 and 404, where the hash values are compared, a human may use a spreadsheet program such as Microsoft EXCEL to compare the hash values. For instance, a consolidated sheet containing all (or a determined subset of) the scripts in script repository 104 and/or the scripts to be uploaded may run through a set of Excel macros that use the HASH column to identify duplicates. Scripts that are textually same may be deleted by the code to avoid multiple copies being present in the repository. Scripts that are functionally same, written on the same table but with different databases, may also be identified as duplicates. Moreover, SQL Scripts already present in the repository may be downloaded based on the HASH values to include them in the duplicate detection process. The whole sheet (with downloaded rows) may then be sorted (such as sorted by hash value), and all the duplicate checksums may be highlighted or otherwise indicated. All highlighted/indicated rows may then be manually verified by a human to confirm duplicates for elimination. Based on the type of duplicate, the duplicate may be either deleted (in case of complete duplicates), or merged (in case of logical duplicates) by script repository maintenance module 105 using an Excel macro. Merging may be performed to combine the information on the tags between duplicates.

While various embodiments have been illustrated and described, it is not intended that these embodiments illustrate and describe all possible forms of the present invention. Rather, the words used in the specification are words of description rather than limitation, and it is understood that various changes may be made without departing from the spirit and scope of the present disclosure.

1. A method, comprising:
storing, in a non-transitory computer-readable medium, data representing a plurality of script entries, each script entry representing a plurality of characteristics of a script and a hash value, the hash value for each of the script entries being based on at least one of the plurality of characteristics of the respective one of the script entries;
determining a plurality of characteristics of a first script;
determining, by a computer, a hash value for the first script based on at least one of the plurality of characteristics of the first script;
comparing the hash value for the first script with the hash value for any of the script entries.

2. The method of claim 1, further comprising loading the script entry for the first script to the non-transitory computer-readable medium, responsive to determining that the hash value for the first script does not match the hash value for any of the script entries.

3. The method of claim 1, further comprising:
loading the script entry for the first script to the non-transitory computer-readable medium; and
tagging the script entry for the first script in the non-transitory computer-readable medium with an indication that the script entry for the first script is a suspected duplicate of another one of the plurality of script entries, responsive to determining that the hash value for the first script matches the hash value of at least one of the script entries.

4. The method of claim 3, further comprising:
determining which of the script entries in the non-transitory computer-readable medium are tagged as a suspected duplicate; and
selectively removing from the non-transitory computer-readable medium at least some of the determined ones of the script entries.

5. The method of claim 1, wherein the hash value for each of the script entries is based on at least two of the plurality of characteristics of the respective script entry.

6. The method of claim 1, wherein determining the hash value for the first script comprises summing coded values of each text character in the at least one of the plurality of characteristics of the first script.

7. The method of claim 1, wherein determining the hash value for the first script comprises summing coded values of each text character in at least two of the plurality of characteristics of the first script.

8. A method, comprising:
storing, in a non-transitory computer-readable medium, data representing a plurality of script entries, each script entry representing a plurality of characteristics of a script and a plurality of hash values, each of the hash values for each of the script entries being based on at least one of the plurality of characteristics of the respective one of the script entries;
determining a plurality of characteristics of a first script;
determining, by a computer, a plurality of hash values for the first script each based on at least one of the plurality of characteristics of the first script;
determining whether one or more of the hash values for the first script matches one or more of the hash values for any of the script entries.

9. The method of claim 8, further comprising loading the script entry for the first script to the non-transitory computer-readable medium, responsive to determining that the hash values for the first script do not match the hash values for any of the script entries.

10. The method of claim 8, further comprising:
loading the script entry for the first script to the non-transitory computer-readable medium; and
tagging the script entry for the first script in the non-transitory computer-readable medium with an indication that the script entry for the first script is a suspected duplicate of another one of the plurality of script entries, responsive to determining that at least one of the hash values for the first script matches at least one of the hash values of at least one of the script entries.

11. The method of claim 10, wherein the indication depends upon how many of the hash values for the first script match hash values of the at least one of the script entries.

12. The method of claim 10, further comprising:
determining which of the script entries in the non-transitory computer-readable medium are tagged as a suspected duplicate; and
selectively removing from the non-transitory computer-readable medium at least some of the determined ones of the script entries.

13. The method of claim 8, wherein at least one of the hash values for each of the script entries is based on at least two of the plurality of characteristics of the respective script entry.

14. The method of claim 8, wherein determining at least one of the hash values for the first script comprises summing coded values of each text character in the at least one of the plurality of characteristics of the first script.

15. The method of claim 8, wherein determining at least one of the hash values for the first script comprises summing coded values of each text character in at least two of the plurality of characteristics of the first script.

16. An apparatus, comprising:
a non-transitory computer-readable medium storing data representing a plurality of script entries, each script entry representing a plurality of characteristics of a script and a hash value, the hash value for each of the script entries being based on at least one of the plurality of characteristics of the respective one of the script entries;
a processor configured to:
determine a hash value for a first script based on at least one of a plurality of characteristics of the first script;
compare the hash value for the first script with the hash values of the script entries; and
cause an indication of an outcome of the comparison to be displayed.

17. The apparatus of claim 16, wherein the processor is configured to determine the hash value by determining summing coded values of each text character in the at least one of the plurality of characteristics of the first script.

18. The apparatus of claim 16, wherein the processor is configured to determine the hash value by determining summing ASCII coded values of each text character in the at least one of the plurality of characteristics of the first script.

19. The apparatus of claim 16, wherein the processor is configured to determine the hash value by determining summing coded values of each text character in the at least two of the plurality of characteristics of the first script.

20. The apparatus of claim 16, wherein the processor is further configured to sort the script entries by hash value, and to cause the sorted script entries to be displayed.
